(19) United States
(12) Patent Application Publication
(10) Pub. No.: US 2021/0088237 A1
(43) Pub. Date: Mar. 25, 2021

(54) Smoke Removal Apparatus

(71) Applicant: Derek Nicholas Planavsky, Orlando, FL (US)

(72) Inventor: Derek Nicholas Planavsky, Orlando, FL (US)

(21) Appl. No.: 17/026,281

(22) Filed: Sep. 20, 2020

Related U.S. Application Data
(60) Provisional application No. 62/903,010, filed on Sep. 20, 2019.

(51) Int. Cl. F24F 7/013; F24F 110/62

(52) U.S. Cl. CPC F24F 7/013; F24F 2110/62

(57) ABSTRACT

The present invention relates generally to a smoke removal apparatus. More specifically, but not in the way of limitation, an apparatus configured to be secured to a window frame of a structure wherein the apparatus is operable to provide isolation of smoke or similar, inhibit propagation thereof into the interior volume of a room, and expel said smoke or similar to an external environment. The present invention includes an interior window frame, at least two arms secured to said window frame, a foldable material operably disposed intermediate the at least two arms and coupled thereto, and at least one exhaust fan configured to draw air towards said window, wherein said exhaust fan expels said smoke or similar to an external environment.

### REFERENCE TO RELATED APPLICATIONS

This patent application claims the benefit of U.S. Provisional Application No. 62/903,010 filed on Sep. 20, 2019, the disclosure of which is incorporated herein by reference in its entirety.

### BACKGROUND OF THE INVENTION

### Field of the Invention

The present invention relates generally to smoke removal, more specifically but not in a way of limitation, a smoke removal apparatus that is affixed or part of an interior window frame wherein the apparatus that is configured to facilitate the exhaust of smoke such as but not limited to cigarette smoke.

### Description of Related Art

Millions of people routinely engage in the act of smoking. Smoking articles such as but not limited to pipes, cigars, and other tobacco products have been a part of human culture for centuries. One popular smoking product is the cigarette. Its packaging makes it a convenient tobacco product to smoke and is consumed by millions of people on a daily basis. Many recent regulations have restricted the utilization of cigarettes and other tobacco products from indoor facilities. Additionally, restricted zones for allowance of smoking are also known in the art. One negative side effect of smoking is the permeation of the smoke into other articles such as but not limited to upholstery and interior walls. This can be especially undesirable for a homeowner that regularly utilizes tobacco products. While the individual may enjoy smoking various tobacco products, the unpleasant negative side effects such as wall discoloration and olfactory permeation can be a nuisance.

Often those individuals who engage in smoking indoors will either stand by an open window or potentially leave the building/residence if feasible. Depending on the climate, leaving one's residence may not be desirable due to inclement weather conditions such as but not limited to severe cold or storms. It is routine during these conditions and at other times the smoker will attempt to be as proximate as possible to an open window and exhales the smoke therethrough. While this does assist in the removal of some smoke, natural airflows and other parameters result in a portion of the smoke remaining within the interior of the structure producing the undesirable negative effects.

It is intended within the scope of the present invention to provide a smoke removal apparatus that is configured to be secured to or a part of a window frame wherein the smoke removal apparatus of the present invention provides expelling of the smoke to the outside of the structure.

Systems for isolating, containing, filtering, venting smoke and the like is known in prior art. More specifically, U.S. Pat. No. 5,085,134 to Hofstra et al. discloses a smoker's booth for receiving and accommodating one or more smokers and for isolating smokers and tobacco smoke, having a walled enclosure, a ceiling, a smoker's access means disposed in said enclosure means for providing ingress and egress for smokers, and a means for venting tobacco smoke from said walled enclosure means and a way from the vicinity proximate to said walled enclosure means, wherein said venting means further directs the tobacco smoke along a single flow path extending forwardly within said smoker's booth, and thereafter extending rearwardly within said smoker's booth, whereby the tobacco smoke is prevented from exiting said smoker's booth through said smoker's access means.

U.S. Patent Application Publication No. 2009/0178687 A1 to Davis teaches a room second hand smoke eliminator which discloses a portable system for venting smoke from tobacco products outdoors comprising a frame defining a volume, a frame defining a volume, a support for an ashtray in the volume at forward in the frame, a rearward opening in the frame, and a fan located adjacent or within the opening with its blades positioned to draw smoke away from the ashtray when the fan blades are turning.

None of the aforementioned inventions recognize and/or address the use of an existing wall or window as a support base. None of the aforementioned inventions are intended for indoor use alone. None of the aforementioned inventions require minimal materials to expel smoke from a defined volume. None of the aforementioned inventions can camouflage into the environment when not in use. None of the aforementioned inventions provide an inexpensive solution to contain and expel smoke. Hence, it is desirable to have a simple and affordable apparatus to remove smoke and inhibit propagation into the interior volume of a room. According to one embodiment of the present invention a permanent or releasably secured apparatus with a frame may include a support base, movable arms, an impermeable material and a fan can be affixed to a window frame to contain and exhaust smoke and fold away when not in use. Overall, a smoke removal apparatus that can be retrofitted to an existing window structure that eliminates the need for additional materials or space to accommodate a smoke removal apparatus would be desirable.

### SUMMARY OF THE INVENTION

It is an object of the present invention to provide a smoke removal apparatus that is configured, to expel tobacco smoke or similar to the external environment of a structure wherein the present invention includes a frame secured to the window of a building.

Another object of the present invention is to provide a smoke removal apparatus operable to remove smoke generated by a person smoking a tobacco product proximate thereto wherein the frame of the present invention is secured to the interior window frame of a window in a building.

A further object of the present invention is to provide a smoke removal apparatus that is configured to expel tobacco smoke or similar to the external environment of a structure where in the frame of the present invention can be either permanently a part of a window frame or releasably secured thereto.

Still another object of the present invention is to provide a smoke removal apparatus operable to remove smoke generated by a person smoking a tobacco product proximate thereto wherein the frame includes at least two arms wherein the two arms are movable intermediate a first position and a second position.

An additional object of the present invention is to provide a smoke removal apparatus that is configured, to expel tobacco smoke or similar to the external environment of a structure wherein in the first position the arms are adjacent a portion of the window frame.

Yet a further object of the present invention is to provide a smoke removal apparatus operable to remove smoke generated by a person smoking a tobacco product proximate thereto wherein in the second position the arms are extended outward from the window frame and inwards towards the interior room.

Another object of the present invention is to provide a smoke removal apparatus that is configured to expel tobacco smoke or similar to the external environment of a structure that further includes a foldable material operably disposed intermediate the at least two arms and coupled thereto.

An alternate object of the present invention is to provide a smoke removal apparatus operable to remove smoke generated by a person smoking a tobacco product proximate thereto wherein the foldable material is manufactured from an impermeable material such as but not limited to plastic.

Still a further object of the present invention is to provide a smoke removal apparatus that is configured to expel tobacco smoke or similar to the external environment of a structure that further includes at least one exhaust fan, wherein the at least one exhaust fan is configured to draw air towards the window.

An additional object of the present invention is to provide a smoke removal apparatus operable to remove smoke generated by a person smoking a tobacco product proximate thereto wherein the at least one person exhaust fan is atmospherically coupled to an environment of the building.

A further object of the present invention is to provide a smoke removal apparatus that is configured to expel tobacco smoke or similar to the external environment of a structure that further includes either an integrated power switch or remote power switch providing operation of at least one exhaust fan.

An alternative objective of the present invention is to provide a smoke removal apparatus operable to remove smoke generated by a person smoking a tobacco product proximate thereto wherein the exhaust fan can be either fixedly mounted or releasably secured.

Yet a further object of the present invention is to provide a smoke removal apparatus that is configured to expel tobacco smoke or similar to the external environment of a structure wherein an embodiment of the frame could further include opposing side curtain-like members.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

Accordingly several advantages of one or more aspects are as follows: to provide smoke removal from the interior of a volume, use of minimal materials to construct the smoke removal apparatus, can be adjustable to fit any size window, cost effective, the apparatus can fold up when not in use to camouflage with environment, can be adapted to include window coverings, compact, lightweight, easy to set up, easy to operate, variable uses, blends into environment, and easy to clean. Other advantages of one or more aspects will be apparent from a consideration of the drawings and ensuing description.

### BRIEF DESCRIPTION OF THE DRAWINGS

A more complete understanding of the present invention may be had by reference to the aforementioned description and the accompanying drawings submitted herewith.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible, By the way of example but not by the way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized, and that other aspects, features, advantages or logical changes may be made without departing from the spirit or scope of the invention. The description may omit certain information known to those skilled in the art. The preceding description is, therefore, not intended to be limited to the specific forms set forth herein, but on the contrary, it is intended to cover such alternatives, modifications, and equivalents, as can be reasonably included within the spirit and scope of the invention.

FIG. 1 illustrates a position 2 perspective view of a permanently affixed smoke removal apparatus in accordance with one embodiment of the present invention.

FIG. 2 illustrates a position 1 perspective view of a permanently affixed smoke removal apparatus in accordance with the art of the present invention as shown in FIG. 1.

FIG. 3 illustrates a position 2 perspective view of a releasably secured smoke removal apparatus in accordance with one embodiment of the present invention.

FIG. 4 illustrates a position 2 perspective view of a releasably secured smoke removal apparatus in accordance with one embodiment of the present invention.

FIG. 5 is a perspective view that illustrates the air flow containment and removal of smoke present in the volume of the smoke removal apparatus.

DRAWING REFERENCE NUMERALS

| | |
|---|---|
| 1. | Window frame |
| 2. | Interior window frame |
| 3. | Window surface |
| 4. | Latch |
| 10. | Cable support mount |
| 11. | Tension rod |
| 12. | Cable support |
| 13. | Arm |
| 14. | Tension rod support mount |
| 15. | Support arm |
| 16. | Pinned support |
| 17. | Fixed support |
| 20. | Foldable material |
| 21. | Curtain-like side member |
| 22. | Front facing curtain-like side member |
| 30. | Fan |
| 31. | Power switch |
| 32. | Airflow restrictor |
| 33. | Fan blades |
| 50. | Smoke |
| 51. | Operator |
| 100. | Permanently affixed smoke removal apparatus |
| 200. | Releasably secured smoke removal apparatus |
| 300. | Simple smoke removal apparatus |

### DESCRIPTION OF THE INVENTION

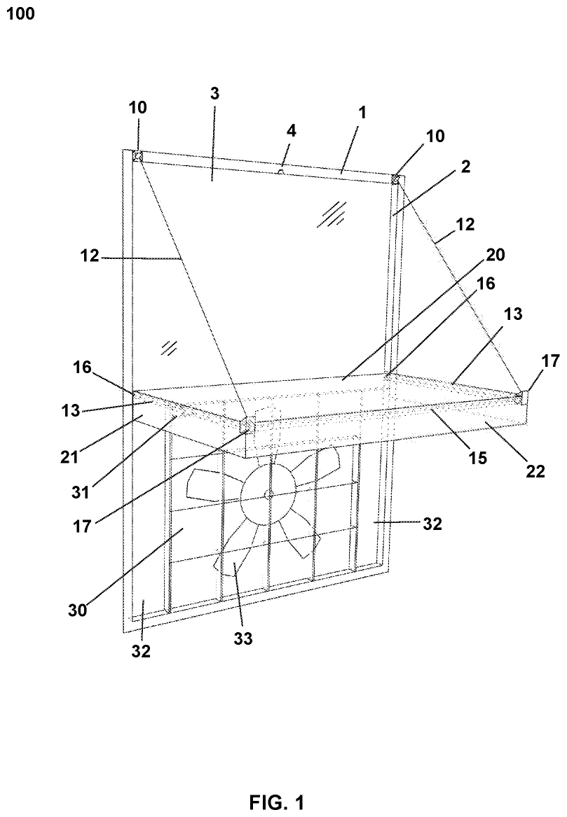

Referring to FIG. 1, there is disclosed an improved apparatus, generally indicated as 100, for containing, venting, exhausting, or expelling smoke and similar materials according to one embodiment of the present invention. As shown the apparatus 100 comprises of a frame secured to a window 3 of a building, wherein the frame is secured to an interior window frame 2 in a building, wherein the frame can be permanently a part of a window frame 1, wherein the frame includes at least two arms 13, wherein two arms 13 are movable intermediate a first position and a second position, wherein second position the arms 13 are extended outward from the window frame 1 and inwards towards the interior room.

A support arm 15 is perpendicular in relationship to arms 13, wherein arms 13 and support arm 15 are joined by a fixed support 17. Connected to one end of arms 13 is a funicular, adjustable, or a cable support 12, wherein one end is coupled to a fixed support 17 and its opposite end is coupled to a tension rod support mount 14, wherein a cable support mount is permanently affixed to a window frame 1. Connected to an opposite end of arm 13 is a pinned support 16, which can be fastened to the interior window frame 2.

The structure further includes a foldable material 20 operably disposed intermediate the at least two arms 13 and coupled thereto, wherein the foldable material 20 is manufactured from an impermeable material such as but not limited to plastic, wherein an embodiment of the frame could further include opposing side curtain-like members 21, wherein a front facing curtain-like member 22 is joined between two side curtain-like members 21, wherein curtain-like members 21 and front facing curtain-like member 22 can be one with foldable material 20 or separate from foldable material 20.

The system 100 employs at least one exhaust fan 30, wherein at least one exhaust fan 30, wherein fan blades 33 are configured to draw air towards the window 3, wherein exhaust fan 30 is atmospherically coupled to the environment of the building, wherein either a remote power switch or an integrated power switch 31 providing operation of at least one exhaust fan 30, wherein exhaust fan 30 can be either fixedly mounted or releasably secured. An airflow restrictor 32 can be coupled between an exhaust fan 30 and an interior window frame 2.

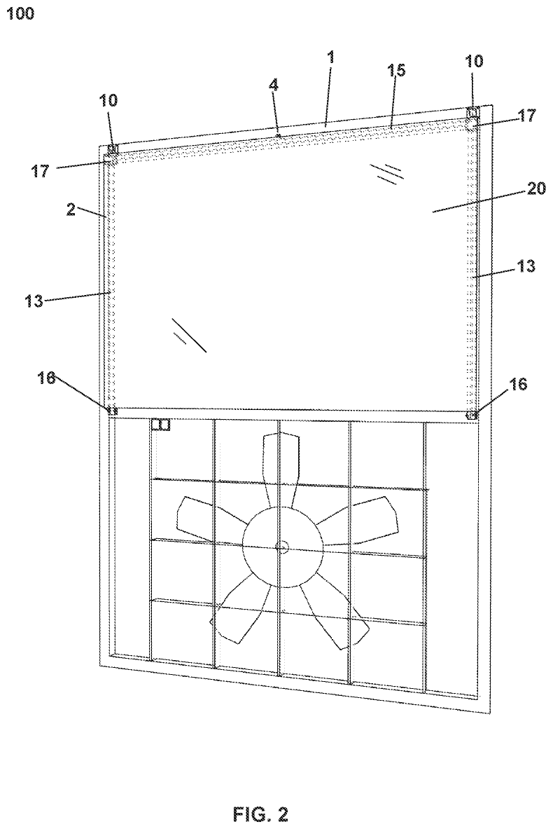

Now referring to FIG. 2 the improved apparatus 100 as shown in FIG. 1 further comprises a latch 4 which is fixed to a window frame 1 to support the apparatus 100, wherein at least two arms 13 are movable intermediate a first position and a second position, wherein in the first position at least two arms 13 are adjacent a portion of interior window frame 2.

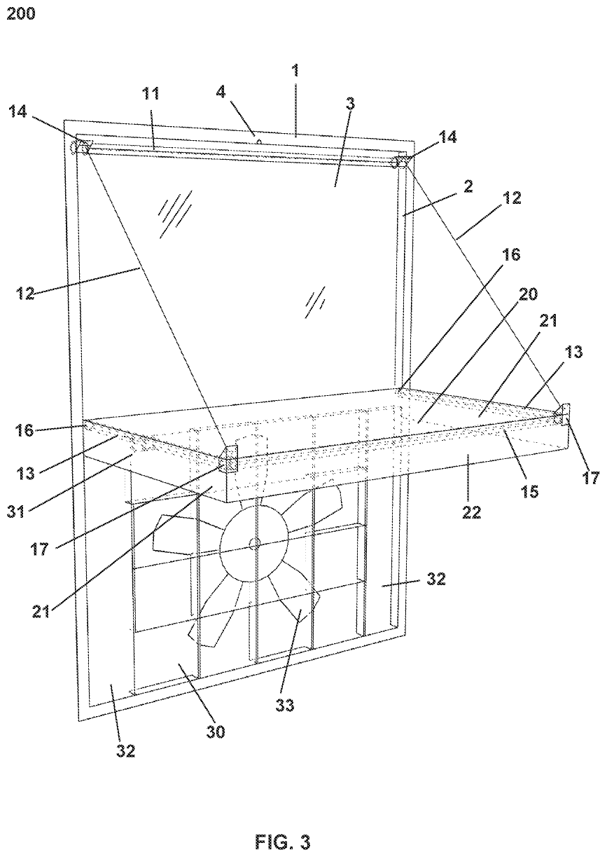

Referring to FIG. 3, there is disclosed an improved system, generally indicated as 200, for containing, venting, exhausting, or expelling smoke and similar materials according to one embodiment of the present invention. As shown the apparatus 200 comprises of a frame secured to a window 3 of a building, wherein the frame is secured to an interior window frame 2 in a building, wherein the frame can be releasably secured a part of a window frame 1, wherein the frame includes at least two arms 13, wherein the two arms 13 are movable intermediate a first position and a second position, wherein in second position the arms 13 are extended outward from the window frame 1 and inwards towards the interior room.

A support arm 15 is perpendicular in relationship to arms 13, wherein arms 13 and support arm 15 are joined by a fixed support 17. Connected to one end of arms 13 is a funicular, adjustable, or a cable support 12, wherein one end is coupled to a fixed support 17 and its opposite end is coupled to a tension rod support mount 14, wherein a tension rod support mount 14 is affixed to an adjustable, expandable, or tension rod 11, wherein the tension rod 11 is releasably mounted between two opposing sides of interior window frames 2. Connected to an opposite end of arm 13 is a pinned support 16, which can be permanently or releasably fastened to interior window frame 2.

The structure further includes a foldable material 20 operably disposed intermediate the at least two arms 13 and coupled thereto, wherein the foldable material 20 is manufactured from an impermeable material such as but not limited to plastic, wherein an embodiment of the frame could further include opposing side curtain-like members 21, wherein a front facing curtain-like member 22 is joined between two side curtain-like members 21, wherein curtain-like members 21 and front facing curtain-like member 22 can be one with foldable material 20 or separate from foldable material 20.

The system 200 employs at least one exhaust fan 30, wherein fan blades 33 are configured to draw air towards a window 3, wherein exhaust fan 30 is atmospherically coupled to an environment of a building, wherein either a remote power switch or an integrated power switch 31 providing operation of at least one exhaust fan 30, wherein exhaust fan 30 can be either fixedly mounted or releasably secured. An air restrictor 32 can be coupled between an exhaust fan 30 and an interior window frame 2.

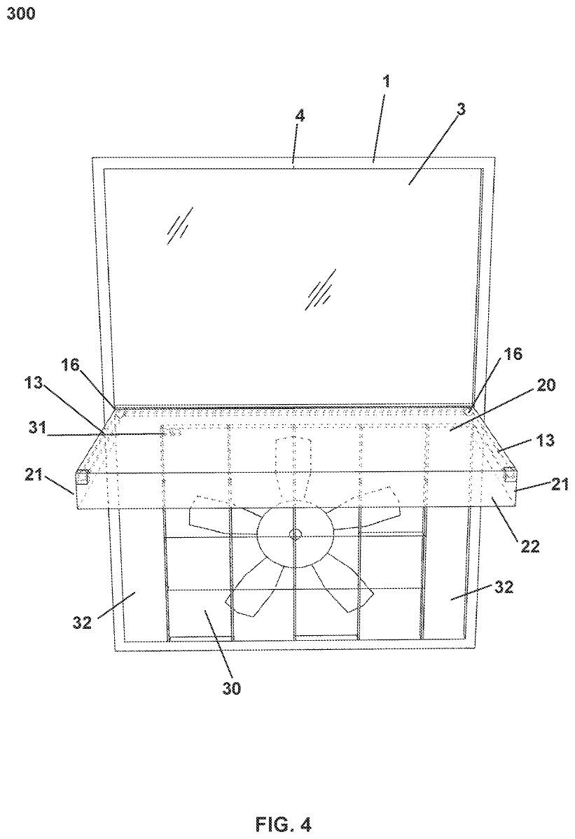

Referring to FIG. 4, there is disclosed an improved system, generally indicated as 300, for containing, venting, exhausting, or expelling smoke and similar materials according to one embodiment of the present invention. As shown the apparatus 300 comprises of a frame secured to a window 3 of a building, wherein the frame is secured to an interior window frame 2 in a building, wherein the frame can be releasably secured a part of a window frame 1, wherein the frame includes at least two arms 13, wherein the two arms 13 are movable intermediate a first position and a second position, wherein in the second position the arms 13 are extended outward from a window frame 1 and inwards towards an interior room. Connected to an opposite end of arm 13 is a pinned support 16, which can be permanently or releasably fastened to an interior window frame 2.

The structure further includes a foldable material 20 operably disposed intermediate the at least two arms 13 and coupled thereto, wherein the foldable material 20 is manufactured from an impermeable material such as but not limited to plastic, wherein an embodiment of the frame could further include opposing side curtain-like members 21, wherein a front facing curtain-like member 22 is joined between two side curtain-like members 21, wherein curtain-like members 21 and front facing curtain-like member 22 can be one with foldable material 20 or separate from foldable material 20.

The system 200 employs at least one exhaust fan 30, wherein fan blades 33 are configured to draw air towards a window 3, wherein exhaust fan 30 is atmospherically coupled to an environment of a building, wherein either a remote power switch or integrated power switch 31 providing operation of at least one exhaust fan 30, wherein an exhaust fan 30 can be either fixedly mounted or releasably secured. An air restrictor 32 can be coupled between an exhaust fan 30 and an interior window frame 2.

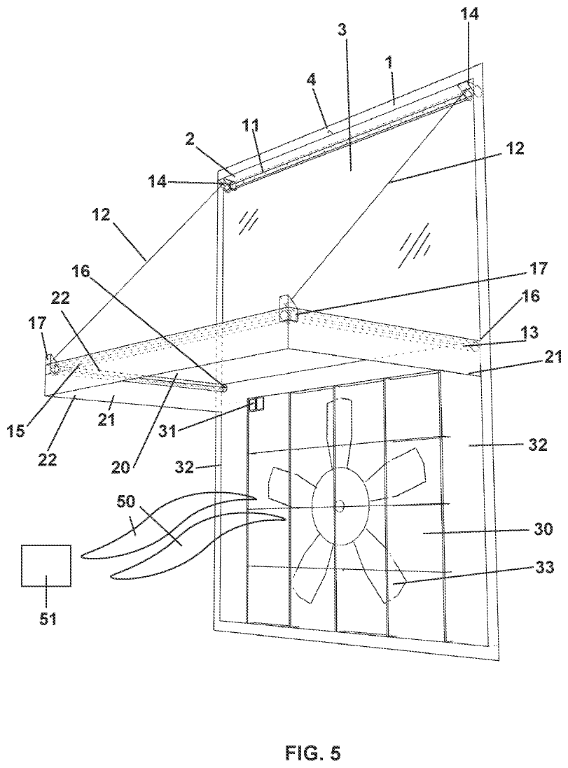

Now referring to FIG. 5 the improved apparatus 200 as shown in FIG. 3 further illustrates airflow of containing, venting, exhausting, or expelling of smoke and similar materials according to one embodiment of the present invention. As shown in FIG. 3 the apparatus 200 further comprises smoke 50 or similar material contained in a volume of the foldable material 20, curtain-like side members 21 and front facing curtain-like side member 22. The system 200 employs at least one exhaust fan 30, wherein fan blades 33 are configured to draw air towards a window 3, an air restrictor 32 can be coupled between an exhaust fan 30 and an interior window frame 2.

The manner of using a smoke removal apparatus when configured as shown in FIGS. 1, 3, 4, and 5 is operable wherein the apparatus is secured as illustrated. An operator 51 can turn on exhaust fan 30 by way of a power switch 31, wherein smoke 50 passes through an open window 3 and expels from a volume of the apparatus to an external environment.

The operator 51 can turn off fan 30 when all smoke 50 has been expelled.
To close the apparatus, an operator 51 can direct the arms 13 upward until the arms 13 are adjacent to a window frame 1, as shown in FIG. 2, and close a latch 4 to secure the apparatus, where in latch 4 is contiguous window frame 1.

It can be appreciated that any or all of the embodiments disclosed above can be used to retrofit an existing or current window and window frame so as to convert these into a smoke removal apparatus for containing, venting, exhausting, or expelling smoke and similar material.

While the above description contains many specifications, these should not be construed as limitations on the scope, but rather as an exemplification of one or several embodiment(s) thereof. Many other variations are possible.

An improved embodiment for containing, venting, exhausting, or expelling smoke and similar materials according to another embodiment of the present invention, wherein movement of the arms 13 from a first position to a second position and from a second position to a first position are operable by automation.

Another improved embodiment of the present invention for containing, venting, exhausting, or expelling smoke and similar materials wherein the frame includes at least two arms wherein the two arms are movable intermediate a first position and a second position, wherein in first position of the arms are adjacent a portion of the window frame, wherein the structure may be configured to camouflage into an environment by way of including blinds or window coverings.

Other materials can be used as foldable material 20, curtain-like side members 21 and front facing curtain-like side members 22 such as, opaque material, adjustable material, inflatable material, glass or other window covering materials.

Arms 13 or 15 can be made of a fixed rigid material, adjustable, collapsible, extendable, retrofitted, or other material.

Cable support mount 10 or tension rod support mount 14 can be fixed, retractable, adjustable or a pulley.

Fixed support 17 can be rigid, collapsible, or adjustable. Components can be as described, retractable, adjustable, remote, manual or automated.

Cable 12 can be a cable, cord, wire, funicular, rigid, expandable, adjustable, or fabric-like.

An embodiment of the present invention can vary in size or adapt size.

An embodiment of the present invention can vary in shape.

An embodiment of the present invention can be operated manually, by an integrated power switch, or a remote power switch.

While there have been shown and described and pointed out the fundamental novel features of embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A system for expelling smoke or like to an external environment of a structure, comprising:
an interior window frame;
at least two arms secured to said interior window frame;
a foldable material operably disposed intermediate the at least two arms and coupled thereto; and
at least one exhaust fan configured to draw air towards the window.

2. A smoke removal apparatus, comprising:
An interior window frame,
At least two arms secured to said window frame,
a foldable material operably disposed intermediate the at least two arms and coupled thereto, and
At least one exhaust fan configured to draw air towards the window,
Wherein said apparatus isolates smoke or similar and said exhaust fan expels said smoke.

3. The system of claim 2, wherein the at least two arms can be permanently a part of a window frame or releasably secured thereto.

4. The system of claim 3, wherein the two arms are movable intermediate a first position and a second position.

5. The system of claim 4, wherein the first position said arms are adjacent to a portion of the window frame.

6. The system of claim 4, wherein the second position said arms are extended outward from said window frame and inwards towards an interior room.

7. The system of claim 2, wherein said foldable material is manufactured from an impermeable material.

8. The system of claim 2, wherein said exhaust fan is atmospherically coupled to an environment of a building or window.

9. The system of claim 8, wherein said exhaust fan can be either fixedly mounted or releasably secured.

10. The system of claim 2, wherein the apparatus can further include opposing side like curtain-like members.

11. The system of claim 2, wherein a support arm can be contiguous said arms.
